(19) United States
(12) Patent Application Publication
(10) Pub. No.: US 2004/0153884 A1
(43) Pub. Date: Aug. 5, 2004

(54) Remote, automatic data service for wireless communications

(76) Inventors: Benjamin S. Fields, Brooklyn, NY (US); Sabrina Grandchamps, Rosedale, NY (US)

Correspondence Address: Attn: Anita Lomartra, McCARTER & ENGLISH, LLP, CityPlace I, 185 Asylum Street, Hartford, CT, 06103, US

(21) Appl. No.: 10/693,399

(22) Filed: Oct. 24, 2003

Related U.S. Application Data
(60) Provisional application No. 60/420,952, filed on Oct. 24, 2002.

(51) Int. Cl. H04L 1/22

(52) U.S. Cl. 714/52

(57) ABSTRACT

An instruction set system (network) for communication devices and other similar electronic devices, both wireless and non-wireless devices that provides a process and means for storing and recalling information, and for coordinating data stored on one of these devices with other digital storage means such as personal computers. The instruction set system (network) provides a mean to enable redundant storage and backup for data stored on these devices that is simple, automatic and requires as little user intervention/interface as possible, by way of employment of specific set of software instructions stored on a semiconductor chip or chip set executable on the dedicated microprocessors controlling communication devices that allow “wireless data acquisition” through the use of both currently available and futuristic wireless networks.

### CROSS-REFERENCE TO RELATED APPLICATIONS

The present application claims priority benefit of Provisional Application Serial No. 60/420,952, filed in the U.S. Patent and Trademark Office on Oct. 24, 2002, the disclosure of which is incorporated herein by reference in its entirety.

### BACKGROUND OF THE DISCLOSURE

1. Technical Field

The present invention relates in general to communication network systems and is particularly directed to a data communication system (e.g.., an aircraft data communication system (network)) located at a base station synchronous with wireless ground links that link respective subsystems (e.g., aircraft-resident subsystems), in each of which a copy of relevant data (e.g., an aircraft's flight performance data) is stored. In an exemplary aircraft-related embodiment of the present disclosure, the system includes airport-located ground subsystems, by way of air traffic control, each ground subsystem being coupled, in turn, by way of respective telecommunication (i.e., “Telco”) links to a remote flight operations control center, where flight performance data from plural aircraft parameters may be analyzed and from which the uploading of in-flight data files may be directed/accessed by airline systems personnel.

2. Background Of The Disclosure

Anyone who walks down the street in a city or town of more than a few hundred souls can testify to the ubiquitous nature of the use of wireless communications technology. As the percentage of the population using wireless communications devices, such as cellular telephones increases, the convenience, sophistication, and range of features of typical wireless communications devices increase exponentially, even as prices for the devices and services utilized through them are decreasing. In addition to the growing feature set of typical devices, the current level of use of such devices can be at least partially attributed to the growing communications networks that support these devices. No longer do most users need to be concerned about where they are positioned physically in terms of being able to successfully communicate wirelessly. In this regard, there are very few areas in the country today where cellular communications networks do not extend.

Parallel to this increased reliance on wireless communications is a likewise growing base of users for handheld, computerized devices, often referred to as Personal Digital Assistants (PDA's) that provide database and rudimentary word processing capabilities in an electronic device not much larger than a package of cigarettes. Interestingly, as the technical capabilities and the feature sets of both wireless communications devices and PDA's increase, the distinction between the devices becomes increasingly blurred. Technologically speaking, it seems inevitable that eventually a new class of devices will emerge in the marketplace that combine all of the essential features if both cellular phones and PDA's into a single device.

As a cell phone becomes capable of storing more and more information of potential benefit to its users, and as PDA's become capable of storing amounts of data that rival the storage capacity of personal computers not many generations removed from today's models, users of these devices inevitably become more and more conscious of processes and means for storing and recalling this information, and for coordinating data stored on one of these devices with other digital storage means such as personal computers. For example, in offices seemingly everywhere popular PDA's can be seen resting in a data communications “cradle” synchronizing stored data and documents between the PDA and the personal computer. In a somewhat similar vein, users of cell phones capable of storing hundreds of phone numbers become increasingly dependent on the on-board data storage and less likely to utilize traditional, “hard-copy” means for storage and retrieval of contact information.

Communication systems and/or networks have also been proposed for other applications. For example, U.S. Pat. No. 6,507,739 to Gross et al. and U.S. Pat. No. 6,522,867 to Wright et al. disclose communication systems having particular applicability to aircraft-related implementations. With particular reference to the Wright '867 patent, a system and method are provided for communicating a “retrievable record” of the flight performance of an aircraft that includes a ground data link unit that obtains flight performance data representative of aircraft flight performance during flight of the aircraft. The Wright '867 patent further discloses a spread spectrum transceiver that is coupled to a data store and operative to download flight performance data that has been accumulated and stored by the data store over a spread spectrum communication signal. A ground base spread spectrum transceiver receives the spread spectrum communication signal from the aircraft and demodulates the signal to obtain flight performance data. A wireless unit is operative with the ground data link unit which may be used for inventory control of products during in-flight servicing of passengers.

A careful examination of U.S. Patent granted to Thomas H. Wright et al, U.S. Pat. No. 6,522,867, entitled, “Wireless, frequency-agile spread spectrum ground link-based aircraft data communication system with wireless unit in communication therewith,” the disclosure of which is incorporated herein by reference, details a system/method wherein:

retrievable record of the flight performance of the aircraft and includes a ground data link unit that obtains flight performance data representative of aircraft flight performance during flight of the aircraft. A spread spectrum transceiver is coupled to a data store and operative to download flight performance data that has been accumulated and stored by the data store over a spread spectrum communication signal. A ground base spread spectrum transceiver receives the spread spectrum communication signal from the aircraft and demodulates the signal to obtain flight performance data. A wireless unit is operative with the ground data link unit. This wireless unit could be for inventory control of products during in-flight servicing of passengers.

The Wright '867 patent outlines a specific means to an end; the use of a well known communications schema, commonly referred to as spread spectrum communications in order to transmit data via a system, or network in order to accomplish its goal. In addition, the Wright '867 patent further details the method in which its present invention will take control and steps to provide some sort of data recovery or backup for flight aviation. It is very important, however, to note that the Wright '867 patent possesses a transmission requirement; the Wright '867 patent requires the transmission of any flight data/information at the point of successful completion of flight/landing in order for the data/information files to be transmitted to any Air Traffic Control (ATC) center.

In light of the increasing reliance on personal electronic devices such as cell phones and PDA's for the storage of critical data and other data-sensitive applications that include the potential for mobility (e.g., aircraft-related applications), a need has developed for means to provide redundant storage and backup for data stored on such mobile (or potentially mobile) devices. The ultimate success of any data backup strategy will depend primarily on whether the execution of the strategy is sufficiently easy to accomplish to maximize the extent of compliance with the strategy. Therefore, a need exists for a means to provide backup data storage for personal digital devices that is simple, automatic and requires as little user intervention/interface as possible.

### BRIEF SUMMARY OF THE INVENTION

In recognition of the foregoing need, the present inventors have developed a novel automatic data backup/recovery method and device for wireless communications and other similar electronic devices. We have coined the name for this device, “WIRELESS ON THE GO,”™ to describe this technology.

Wireless On the GO™ (“WOTG”) provides a set of software instructions stored on a semiconductor chip or chip set executable on the dedicated microprocessors controlling wireless communications devices that allows “wireless data acquisition” through the use of both currently available and futuristic wireless networks (Local Area Networks (LAN), Metropolitan Area Networks (MAN), Wide-Area Networks (WAN)) and so forth. As would be appreciated by one of skill in the art, there are a number of technical avenues that can be followed to both create these instructions in a machine-readable form, and permanently or reversibly store these instructions on semiconductor devices. The disclosure contained herein is not designed to limit the practice of the present invention to a single or preferred embodiment but is intended to illustrate the overall concepts of the invention and, as such, should not be considered limiting of the scope of the invention. The programmed chip or chip set of the invention communicates wirelessly with a dedicated server to create a backup of the data on handheld devices, primarily, yet, not only directed toward cellular phones. The chip or chip set will be located within the cellular phone or other digital device and is able to communicate with both the device's internal memory and the database located on the WOTG server.

The instructions programmed into the chip or chip set will, at predetermined time intervals, execute a status check on the contents of the device's stored memory to determine if the contents of the memory have changed since the check was last executed. If this check returns a result indicating that the memory contents have changed, instructions will be executed to retrieve the stored data. Under the control of commands executed by the chip or chip set, the device will then attempt to connect to the server. When the connection to the server is made, the data will be sent by the chip to the database and stored there as a backup copy of the data that remains on the handheld device. The user will still be able to use the device during the entire process. After the data is sent and stored, the chip or chip set will return to a “dormant” or rest state until it is again time to check the memory contents.

Preferably, the semiconductor chip or chip set has a storage capacity at least as large as that of the device's dedicated memory. When commands are executed to retrieve data/information from the device's memory, that data set will remain in memory dedicated to that purpose, and under control of the chip or chip set, until the next command is executed to compare that stored data set with the current data set of the digital device.

In addition to an embodiment designed to implement automatic, remote data storage through wireless communication devices, the present invention contemplates embodiments involving several significantly different applications. The present invention has potential utility for the automatic remote backup of stored data from a number of different sources. One of these sources which claim great importance is the “black box” which are currently employed in all commercial airplanes and utilities of the like with inner components such as: the Cockpit Voice Recorder (CVR), Flight Data Recorder (FDR), and Flight Data Acquisition Unit (FDAU); simply to name a few.

According to this embodiment of the present invention, a wireless communications device which typically contains a semiconductor chip or chip set programmed to execute instructions as described generally above, or otherwise programmed to function without direct user intervention will be provided in direct electronic communication with the flight data acquisition unit (FDAU) usually located under the cockpit of the airplane. The FDAU collects data through sensors located in various positions on the airplane and sends the collected data to the “black box”, which is located in the rear of the plane. The “black box” houses the CVR/FDR units. A device according to the present invention will send accumulated data to a remote site according to a predetermined schedule. The nature of the data that will be sent will include, but is not limited to, a recording of pre-amplified sounds and voices from the cockpit as well as the following parameters: time, pressure, altitude, airspeed, vertical acceleration, magnetic heading, control-column position, rudder-pedal position, control-wheel position, horizontal stabilizer, and fuel flow.

The employment of this instruction set invention can be extended within many types of technology, both currently available today and those which will be in the near future; Personal Digital Assistants (PDA's), advanced cellular technology, advanced digital technology, and mobile/non-mobile computing technology.

Additional advantageous features and functionalities associated with the systems and methods of the present disclosure will become apparent to persons of ordinary skill in the art based on the detailed description which follows and with reference to the appended figures.

### BRIEF DESCRIPTION OF THE DRAWINGS

To assist those of ordinary skill in the art to which the subject matter of the present disclosure appertains, reference is made to the figures appended hereto, wherein:

FIG. 1 depicts a flowchart of an exemplary step-by-step operation taken by the instruction set which is employed when operated on communication device(s) according to the present disclosure; and

FIG. 2 depicts a flowchart diagram of the components that will/can be monitored by use of the instruction set process of FIG. 1.

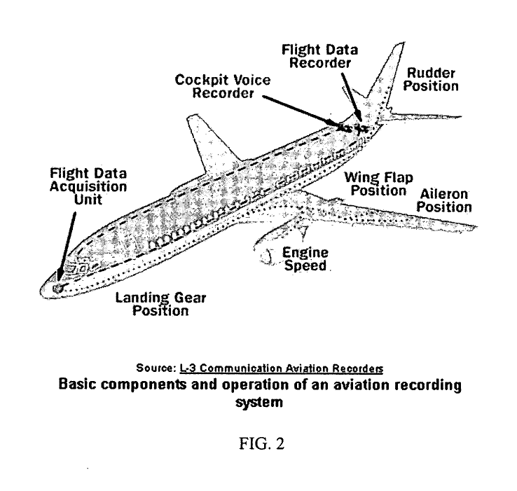

### DETAILED DESCRIPTION OF THE EXEMPLARY EMBODIMENT(S)

Clearly, the present invention solves a problem. It solves the problem of continued loss of data/information, which at the present time is largely taken for granted. In one aspect, the present invention provides a method for operating a redundantly non-user operated/initiated wireless network that is configured for communications with a multiplicity of independently operated data sources via a non-proprietary network. Preferably, the method includes steps for creating “send data object” information that includes user/system inputs, and automatically sending the send data object to a selected device wirelessly, all of which will occur upon establishment of a communication link by way of a series of a previously configured instruction set, without the triggering of user inter-action.

According to one aspect, the present invention provides a method for operating a mobile station that is configured for wireless communications with a multiplicity of independently-operated data sources via a non-proprietary network, which includes steps for creating a send data object that includes user inputs, and automatically sending the send data object to a selected one of the data sources in response to activation of the data transport function; triggered by way of the instruction set configured for this network. According to another aspect, the present invention provides a method for operating a station that is configured for communications with a multiplicity of independently operated data sources via a non-proprietary network. Advantageously, the method includes steps for creating a send data object that includes vital information, automatically and repeatedly, yet redundantly, transporting one or more data objects from a selected one of the data sources in accordance with both a pre-defined wireless network-based-modifiable schedule, and automatically sending the send data object to the selected one of the data sources in response to the transporting which occurs at commencement of communication as cleared/established via the network.

According to a further aspect, the present invention provides software (instruction set), which will be stored on a computer-readable storage medium (chip or chip set), which will be previously configured for communications with a multiplicity of independently operated data sources via a non-proprietary network. Preferably, the software provides a plurality of functions including a fetch data transport function that fetches one or more data objects from a selected one of the data sources, and a send data transport function that automatically sends a send data object to the selected one of the data sources in response to activation of the fetch data transport function, wherein the send data object comprises information that is only accessible via the network that has been in a state condition.

A prime example of the advantage of this implementation from the prior art:

In the past and even in some present situations, there have been situations in which the location of the “black box” became a great crisis. With the addition of this instruction set ‘device’ will be the lightened pressure/load to find the “black box” after an airplane accident. Although the information is stored at a remote site previously defined, the “black box” may be a secondary source of the retrieval of data/information if any connection is ever lost between our instruction set device and the remote backup site.

It should be observed that the present invention resides, at least in part, in what is effectively a prescribed, yet non-binding, arrangement of instruction set procedures, wherein conventional communication circuits, associated digital signal processing components, and control circuitry function to control the ‘particular’ operation behind the innovation at hand. Therefore, the configuration of such circuits, components, and the manner in which they are interfaced or arranged with other communication system equipment have, for the most part, been implemented for many years; of significance for the present invention is effectively operating the disclosed instruction set procedures as part of or in conjunction with such conventional systems/applications/networks, i.e., implementation of the instruction set is of key importance.

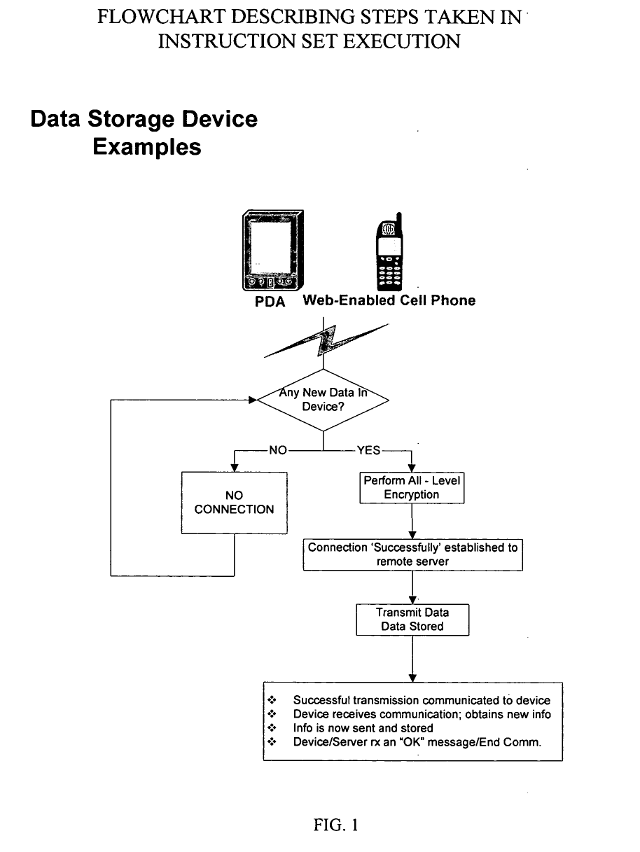

This invention can best be understood by reference to the accompanying drawings. Illustrated in the drawing labeled FIG. 1 by use of the algorithmic flowchart method are the exact procedures that occur in an exemplary embodiment of the present disclosure. The algorithmic flowchart method has been utilized; so as to provide an easy and readily understandable diagram and not obscure the disclosure with details that would be readily apparent to those skilled in the art. Thus, many details concerning conventional systems/applications/networks are not described because such details will be readily apparent to those skilled in the art having the benefit of the description herein. Thus, the diagram illustrates the primary intentions behind the major components of the system (network) whereby the present invention may be much more readily understood.

This invention can best be understood by reference to the accompanying drawing labeled FIG. 1, which presents a network overview for purposes of an exemplary embodiment of the present invention. An assimilation of FIG. 1 is as follows:

PDA/Web Enabled Cell Phone

This provides a basic, quick idea of the types of devices in which the present invention may be used; however, the invention is not limited to just these two devices. The present invention, tries in its very best, to reach out to as many different avenues of any sort/kind of ‘data storage’ device in order to provide service to a much needed cause. Some additional examples of such devices, which could utilize the present invention that are classified as ‘data storage’ devices are: cameras, laptops, desktops, watches, disks (of all types), servers, silos (these are usually located at most data centers where they are huge data storage devices that are normally robotically inclined), new up-and-coming technologies, etc. just to name a few. The instruction set will only communicate with these types of devices by way of a check sequencing procedure available via developers whom are skilled in the art to produce such technology. Such a system management scheme effectively corresponds to that employed in the U.S. Patent to Thomas H. Wright et al, U.S. Pat. No. 6,522,867, entitled, “Wireless, frequency-agile spread spectrum ground link-based aircraft data communication system with wireless unit in communication therewith,” the disclosure of which is incorporated herein by reference. A further assessment can be gained by way of reference to U.S. Patent granted to Jonathan H. Gross et al, U.S. Pat. No. 6,507,739, entitled “Apparatus and methods for controlling a cellular communications network having airborne transceivers,” the disclosure of which is hereby incorporated herein by reference.

Any New Data In Device?

Data can typically range from a personal entry (telephone number, memo, etc.) on towards a simple keystroke on a ‘data storage device’. Once this acknowledgement has been established, a checking procedure is in place to begin. If this has NOT been the case, a case statement “NO” will be sent to the instruction set; the instruction set will run its course up until new data has been identified; a continuous loop will handle this procedure.

Once the instruction set has realization of new information/data within the device, a case statement “YES” will be sent to the instruction set; it can advance forward to steps that cause the automatic data communication of the present invention to take place. This realization is a very important stepping-stone of the process within the instruction set methodology.

Perform All-Level Encryption

Encryption is a way to code or cipher information/data for, example a file, using a secret code so as to be unintelligible to unauthorized parties. The art of encryption to one in the skilled art is known as cryptography, a way to convert plaintext into cipher text (text which has been en-coded) in order to prevent anyone but the intended recipient from reading that data. To date, there are many types of data encryption, and they are the basis of network security. Common types of data encryption include Data Encryption Standard (DES), and public-key encryption (PKE). Encryption plays a major role in highly important transactions that take place on a daily basis.

Once the instruction set has communicated its ‘new information’ status to the system (network) in place, a sequence of encryption steps will begin, which are generally predetermined and well known to persons of ordinary skill in the art. This sequence will cause an initiation of the most basic form of encryption to begin; ranging from high-level to low-level encryption. The encryption will, as mentioned above, allow the device(s) to which it is communicating only to pass data to the next stage in the instruction set. At this point in the instruction set run through of the procedure, a ‘successful connection’ has been received and transmitted to both parties on either end; the data storage process has begun.

The information, which may be either uploaded or downloaded either way, may include data such as, but not limited to; personal data entry information, memorandum data, audio, video, data; information that would be included in an airplane data communication transmission, for example would typically contain next flight information data, parameter-exceedence limit(s), next flight navigation information, including, but not limited to, a navigation database associated with the flight plan of the aircraft, as well as digitized video and audio files that may be employed as part of an even greater service to both passengers and aviation officials.

Transmit Data/Data Stored

As those skilled in the art are aware, data sent via a transmitter to receiver or vice versa requires a successful receipt that the information sent has been received error-free. Methods are in place to accommodate these means for successful transmission. The instruction set employed provides the message sent is received error-free and sends such an acknowledgement that the data information has been accepted correctly. Upon completion of this instruction set process, the entire process iterates repeatedly.

Clearly the present invention is unlike prior art teachings in that it provides enhanced and advantageous redundant, wireless data acquisition at all levels in a great deal of electronic devices. The present invention foresees communication failure, flight failure, and even devastating accidents that could occur during any flight and compensates for these; the data/information is redundantly stored at a location at discretion with respect to each individual device at predetermined instances where, for example, an Air Traffic Control (ATC) center may be aware of all ongoing events occurring on board a flight at present time. This clearly provides a breakthrough in data recovery, safety, and data/information storage for not only aviation, but for any device, which stores electronic data.

In the foregoing detailed description, reference is made to the accompanying drawings, which form a part hereof, and in which are shown by way of illustration specific embodiments in which the invention may be practiced. These embodiments are described in sufficient detail to enable those skilled in the art to practice the invention. The foregoing detailed description uses terms that are provided in order to make the detailed description more easily understandable. It is to be understood that these terms and the phraseology employed in the description should not be construed to limit the scope of the invention. It will be understood by those skilled in the art that the operations of the methods shown and described herein can be carried out in a different order than those described with reference to FIG. 1. It will be appreciated by those of ordinary skill in the art that any arrangement, which is calculated to achieve the same purpose, may be substituted for the specific embodiment shown. For example, although the description refers to implementing various functions of the present invention in particular network elements, many of these functions could be moved to other elements. This application is intended to cover any adaptations or variations of the present invention that fall within its scope. The foregoing detailed description, therefore, is not to be taken in a limiting sense, and it will be readily understood by those skilled in the art that various changes in the details, materials, and arrangements of the parts and operations which have been described and illustrated in order to explain the nature of this invention may be made without departing from the spirit and scope of the invention as expressed in the appended claims.

1. A system for effecting redundant data storage, comprising:
a device that includes a local memory storage, a first communication element that permits communication with a remote data storage location, and a chip that is programmed with an instruction set, and
a remote data storage location that includes a second communication element that permits communication with said first communication element,
wherein said instruction set includes: (i) one or more commands that cause automatic communication with said memory storage on a predetermined periodic basis to determine whether contents within said local memory storage have been modified relative to a prior communication with said memory storage; and (ii) one or more commands that cause automatic communication between said first communication element and said second communication element if it is determined that contents within said local memory storage have been modified relative to said prior communication with said local memory storage, said communication being effective to reposit said contents in a redundant manner within said remote data storage location.

2. A system according to claim 1, wherein said chip is a single semiconductor chip or a chip set.

3. A system according to claim 1, wherein said chip is executable on a dedicated microprocessor associated with said device.

4. A system according to claim 1, wherein said automatic communication between said first communication element and said second communication element is wireless.

5. A system according to claim 1, wherein said automatic communication between said first communication element and said second communication element is over a wired network.

6. A system according to claim 1, wherein said device is selected from the group consisting of a personal digital assistant, a cellular phone, a camera, a laptop computer, a desk top computer, a watch, a disc player, a server and a silo.

7. A system according to claim 1, wherein said device is a black box recorder associated with an airliner.

8. A system according to claim 7, wherein said black box recorder includes data collected by at least one of a cockpit voice recorder, a flight data recorder, a flight data recorder and a flight data acquisition unit.

9. A system according to claim 7, wherein said contents of local memory storage includes data selected from the group consisting of pre-amplified sounds from the cockpit, pre-amplified voices from the cockpit, time pressure, altitude, airspeed, vertical acceleration, magnetic heading, control-column position, rudder-pedal position, control-wheel position, horizontal stabilizer, fuel flow and combinations thereof.

10. A system according to claim 1, wherein said chip is further programmed to cause encryption of said contents before communication to said remote data storage location.

11. A system according to claim 1, wherein said contents of said local memory storage define a send data object for communication to said remote data storage location.

12. A method for establishing redundant data storage for data stored within a mobile device, comprising:
(a) providing said mobile device with a local memory storage, a first communication element that permits communication with a remote data storage location, and a chip that is programmed with an instruction set, wherein said instruction set includes: (i) one or more commands that cause automatic communication with said memory storage on a predetermined periodic basis to determine whether contents within said local memory storage have been modified relative to a prior communication with said memory storage; and (ii) one or more commands that cause automatic communication between said first communication element and a second communication element associated with a remote data storage location if it is determined that contents within said local memory storage have been modified relative to said prior communication with said local memory storage;
(b) automatically determining whether data stored within said local memory storage has been modified; and
(c) if data stored within said local memory storage has been modified, automatically communicating said data to a remote data storage location.

13. A method according to claim 12, wherein said communication with said remote data storage location is wireless.

14. A method according to claim 12, wherein said mobile device is selected from the group consisting of a personal digital assistant, a cellular phone, a camera, a laptop computer, a watch, a disc player, a server and a silo.

15. A method according to claim 12, wherein said mobile device is a black box recorder associated with an airliner.

16. A method according to claim 15, wherein said black box recorder includes data collected by at least one of a cockpit voice recorder, a flight data recorder, a flight data recorder and a flight data acquisition unit.

17. A method according to claim 16, wherein said contents of local memory storage includes data selected from the group consisting of pre-amplified sounds from the cockpit, pre-amplified voices from the cockpit, time pressure, altitude, airspeed, vertical acceleration, magnetic heading, control-column position, rudder-pedal position, control-wheel position, horizontal stabilizer, fuel flow and combinations thereof.

18. A method according to claim 12, wherein said chip is further programmed to cause encryption of said contents before communication to said remote data storage location.

19. A method according to claim 12, wherein said contents of said local memory storage define a send data object for communication to said remote data storage location.

20. A method according to claim 12, further comprising communication data from said remote data storage location to said local memory storage of said mobile device.
